(19) United States
(12) Patent Application Publication
(10) Pub. No.: US 2009/0187906 A1
(43) Pub. Date: Jul. 23, 2009

(54) SEMI-ORDERED TRANSACTIONS

(75) Inventors: Paul Caprioli, Santa Clara, CA (US); Martin Karlsson, San Francisco, CA (US); Shailender Chaudhry, San Francisco, CA (US)

Correspondence Address: PVF -- SUN MICROSYSTEMS INC.;C/O PARK, VAUGHAN & FLEMING LLP, 2820 FIFTH STREET, DAVIS, CA, 95618-7759, US

(73) Assignee: SUN MICROSYSTEMS, INC., Santa Clara, CA (US)

(21) Appl. No.: 12/018,417

(22) Filed: Jan. 23, 2008

(51) Int. Cl. G06F 9/46

(52) U.S. Cl. 718/101

(57) ABSTRACT

Embodiments of the present invention provide a system that facilitates transactional execution in a processor. The system starts by executing program code for a thread in a processor. Upon detecting a predetermined indicator, the system starts a transaction for a section of the program code for the thread. When starting the transaction, the system executes a checkpoint instruction. If the checkpoint instruction is a WEAK_CHECKPOINT instruction, the system executes a semi-ordered transaction. During the semi-ordered transaction, the system preserves code atomicity but not memory atomicity. Otherwise, the system executes a regular transaction. During the regular transaction, the system preserves both code atomicity and memory atomicity.

### BACKGROUND

1. Field of the Invention

Embodiments of the present invention relate to mechanisms that facilitate transactional memory in computer systems. More specifically, embodiments of the present invention relate to systems that facilitate semi-ordered transactions.

2. Related Art

Computer system designers have recently been designing computer systems that execute sections of program code transactionally. During a transaction, a processor completely executes a section of code associated with a transaction, but prevents the results from affecting the architectural state of the system until the transaction successfully completes. For example, in order to prevent the results of a transaction from affecting the architectural state of the system, some processors buffer stores encountered during the transaction in a store buffer and record which cache lines have been accessed during the transaction by placing special load-marks and store-marks on the cache lines which are loaded from and stored to during the transaction. When the transaction successfully completes, the processor atomically commits the results of the transaction to the architectural state of the system.

During a transaction, other threads or processors are permitted to access marked cache lines. However, if another thread or processor performs an “interfering access” to a marked cache line that could result in incorrect data being returned or corruption of the data in the cache line, the transaction fails. For example, if another processor in the system stores to a load-marked cache line, the transaction fails. (Note that alternatively the system may force the other thread or processor to stall the memory access until the transaction completes).

By preventing interfering accesses by other threads or processors during a transaction and atomically committing the results of a successful transaction, the processor guarantees the atomicity of the transaction from the perspective of the memory system (which we call “memory atomicity”). Although atomicity is guaranteed for the above-described transactions, significant performance degradation can result from ensuring such atomicity. Programmers have consequently avoided using transactions unless ensuring atomicity is strictly necessary.

What is needed is a computer system that ensures the “all or none” execution of the code within the transaction, which we call code atomicity, during transactional execution without the above-described problems.

### SUMMARY

Embodiments of the present invention provide a system that facilitates transactional execution in a processor. The system starts by executing program code for a thread in a processor. Upon detecting a predetermined indicator, the system starts a transaction for a section of the program code for the thread. When starting the transaction, the system executes a checkpoint instruction. If the checkpoint instruction is a WEAK_CHECKPOINT instruction, the system executes a semi-ordered transaction. During the semi-ordered transaction, the system preserves code atomicity but not memory atomicity. Otherwise, the system executes a regular transaction. During the regular transaction, the system preserves both code atomicity and memory atomicity.

In some embodiments, when preserving code atomicity, the system either successfully executes each instruction in the transaction or fails the transaction. On the other hand, when preserving memory atomicity, the system either protects each memory location accessed during the transaction from interfering accesses by other threads during the transaction or fails the transaction.

In some embodiments, when starting the semi-ordered transaction, the system stores at least one transactional-failure code from a transactional-failure field included in the WEAK_CHECKPOINT instruction.

In some embodiments, if an instruction in the section of the program code causes an error during the semi-ordered transaction, the system fails the semi-ordered transaction. The system then obtains the stored transactional-failure code from the WEAK_CHECKPOINT instruction. Next, the system executes program code specified by the transactional-failure code.

In some embodiments, when executing the program code indicated by the transactional-failure code, the system executes error-handling code starting at a transactional failure program counter (failPC) included in the transactional-failure code.

In some embodiments, when executing a checkpoint instruction, the system generates a checkpoint to save the precise architectural state of the processor to enable recovery of a program state prior to starting the transaction.

In some embodiments, when executing program code specified by the transactional-failure code, the system determines if a transaction is to be re-executed. If so, the system restores the architectural state of the processor using the checkpoint and re-executes the transaction. Otherwise, the system either restores the checkpoint and executes the code non-transactionally, or executes separate error-handling program code.

In some embodiments, when detecting the predetermined indicator, the system detects a special instruction or a pattern in the program code that indicates the start of a transaction.

### BRIEF DESCRIPTION OF THE FIGURES

FIG. 1 presents a block diagram of a computer system in accordance with embodiments of the present invention.

FIG. 2 presents a block diagram of a processor in accordance with embodiments of the present invention.

FIG. 3 presents a block diagram of an L2 cache in accordance with embodiments of the present invention.

FIG. 4 presents a flowchart illustrating the process of executing a regular transaction in accordance with embodiments of the present invention.

FIG. 5 presents a flowchart illustrating the process of executing a semi-ordered transaction in accordance with embodiments of the present invention.

FIG. 6 presents a flowchart illustrating the process of reordering program code in accordance with embodiments of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

### Overview

Embodiments of the present invention provide a system which facilitates execution of a semi-ordered transaction within a transactional memory system. Some embodiments further provide a WEAK_CHECKPOINT instruction that causes a processor (such as processor 102 (see FIG. 2)) to start a semi-ordered transaction for a transactional section of program code.

In a typical transactional memory system, processor 102 executes a section of the program code that is to be protected from interference by other threads or processes in a “transaction” (which we call a “regular transaction” to distinguish it from a semi-ordered transaction). During a regular transaction, the system buffers any transactional results to a store buffer and defers updating the architectural state of the system with the transactional results until the transaction completes. The system also places special load-marks and store-marks on cache lines loaded from or stored to during the regular transaction. When the section of program code has been completely executed within the regular transaction, processor 102 atomically commits any resulting transactional results to the architectural state of the system.

During the regular transaction, if another thread interferes with the transaction or if a transactional instruction causes an error, the transaction fails. When a regular transaction fails, processor 102 deletes the transactional results and either re-executes the section of the program code or executes another section of the program code, such as an error handler.

Semi-ordered transactions and regular transactions are similar in many respects. For example, semi-ordered transactions completely execute the transaction before the transactional results are committed to the architectural state of the system, which means that they buffer any transactional results to a store buffer and defer updating the architectural state of the system during the transaction. In addition, if the semi-ordered transaction fails, processor 102 deletes the transactional results and either executes another section of the program code (e.g., an error handler) or re-executes the section of the program code.

However, unlike regular transactions, semi-ordered transactions do not guarantee that memory locations accessed by transactional instructions will be protected from interfering accesses by other threads or processors. In addition, semi-ordered transactions do not atomically commit transactional results to the architectural state of the system. In other words, unlike regular transactions, semi-ordered transactions do not guarantee “memory atomicity.”

Because semi-ordered transactions do not guarantee memory atomicity, semi-ordered transactions can be used in situations where memory atomicity is not required. For example, using a semi-ordered transaction, sections of program code can be reordered to enable more efficient execution of program code without incurring some of the overhead inherent in maintaining memory atomicity.

### Computer System

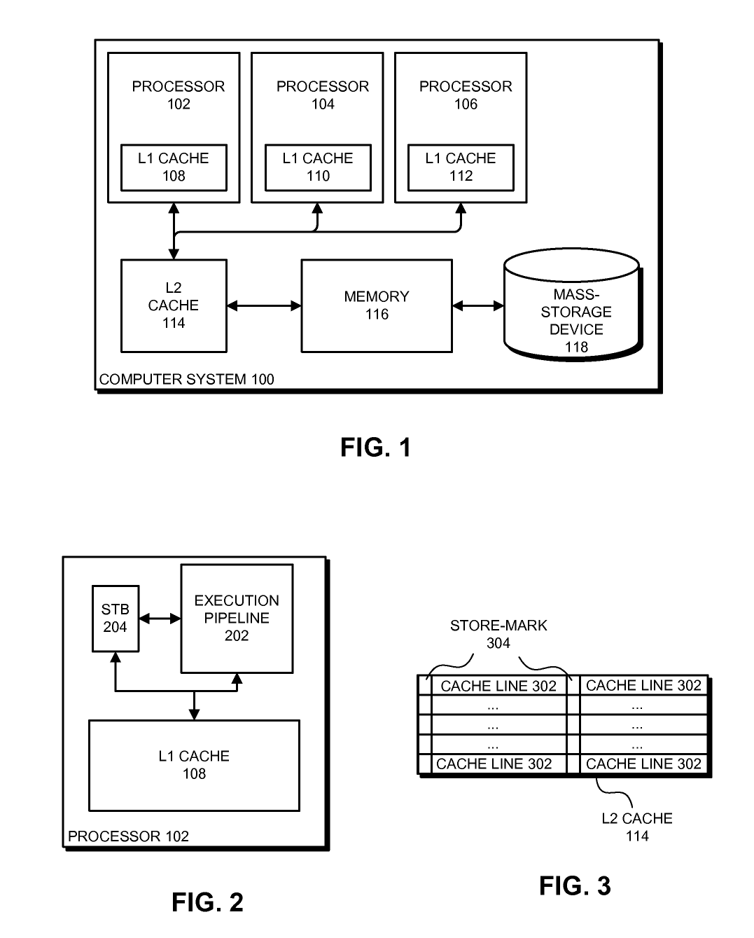

FIG. 1 presents a block diagram of a computer system 100 in accordance with embodiments of the present invention. Computer system 100 includes processors 102, 104, and 106. Each processor 102, 104, and 106 is a separate processing unit that performs computational operations. Moreover, each processor 102, 104, and 106 executes instructions for one or more execution threads (or strands). The operation of a processor which executes threads is known in the art and is therefore not described in more detail.

Processors 102, 104, and 106 include L1 caches 108, 110, and 112, respectively, and the processors share L2 cache 114, memory 116, and mass-storage device 118. Each L1 cache stores data for the corresponding processor, while shared L2 cache 114, memory 116, and mass-storage device 118 can store data for all of the processors. Generally, mass-storage device 118 is a high-capacity memory, such as a disk drive or a large flash memory, with a large access time, while the L1 caches, L2 cache 114, and memory 116 are smaller, faster memories that store copies of frequently used data. Memory 116 is typically a dynamic random access memory (DRAM) structure that is larger than L1 caches or L2 cache 114, whereas the L1 caches and L2 cache 114 are typically comprised of static random access memory (SRAM). Such memory structures are well-known in the art and are therefore not described in more detail.

Although we use processors 102-106 and a set of caches 108-112 and 114 as exemplary components in computer system 100, in alternative embodiments, different types of components can be present in computer system 100. For example, computer system 100 can include video cards, network cards, optical drives, and/or other peripheral devices that are coupled to the one or more of the processors and/or the L2 cache using a bus, a network, or another suitable communication channel.

Computer system 100 can be used in electronic devices such as a desktop computer, a laptop computer, a media player, an appliance, a personal digital assistant (PDA), a controller, a server, a networking device, a cellular phone or smart phone, and other such electronic devices.

FIG. 2 presents a block diagram of a processor 102 in accordance with embodiments of the present invention. Processor 102 includes L1 cache 108, execution pipeline 202, and store buffer (STB) 204.

Execution pipeline 202 includes circuits for performing computational operations. The circuits are divided into a number of pipeline stages to simplify control and to ensure efficient use of computational resources. Execution pipelines are known in the art and are therefore not described in more detail.

STB 204 is used to buffer stores during transactional execution. The buffered stores are held in STB 204 until the transaction successfully completes. Processor 102 then commits the buffered stores to the architectural state of computer system 100 (i.e., to L1 cache 108, L2 cache 114, and possibly to the memory (not shown)). Note that buffering the stores in STB 204 during the transaction enables processor 102 to prevent the transactional results from affecting the architectural state of computer system 100 until the transaction successfully completes.

FIG. 3 presents a block diagram of an L2 cache 114 in accordance with embodiments of the present invention. L2 cache 114 includes a number of cache lines 302 and a store-mark 304 associated with each cache line 302. Cache lines 302 hold cached data, while a store-mark 304 is metadata for the associated cache line 302. When store-mark 304 is set (e.g., non-zero), the associated cache line 302 has been stored to during a transaction. However, if store-mark 304 is unset (e.g., zero), the associated cache line 302 has not been stored to during a transaction. Note that although not shown in FIG. 3, L2 cache 114 includes a load-mark in the metadata associated with each cache line. Moreover, each L1 cache (e.g., L1 cache 108) can include both load-marks and/or store-marks for each of a set of cache lines included in the L1 cache.

Generally, load-marks and store-marks are preferentially placed on cache lines in the cache that is the closest (in terms of access time) to the processor (e.g., processor 102). For example, L1 cache 108 is the closest in terms of access times to processor 102, so marks placed by processor 102 are preferentially placed on cache lines in L1 cache 108, instead of L2 cache 114. However, in some embodiments of the present invention, store-marks 304 are placed on cache lines in L2 cache 114 because, even though L2 cache 114 takes longer to access (i.e., for setting, reading, and removing the store-mark), L2 cache 114 is the most effective location for the marks because the cache lines in L2 cache 114 are loaded from or stored to by the other threads in the system.

### Memory Atomicity and Code Atomicity

In the following sections, we refer to “memory atomicity” and “code atomicity” in association with different types of transactions. By guaranteeing memory atomicity, embodiments of the present invention guarantee that: (1) all the transactional results will appear to be committed to memory at the same time from the perspective of any other thread or processor (i.e., there are never any partial transactional results visible to other threads or processors); and (2) no other thread or processor will be allowed to perform an access of a load-marked or store-marked cache line that could result in a return of incorrect data and/or the corruption of the data in the marked cache line from the perspective of either the transaction or any other thread or processor (an “interfering access”) or the transaction will fail.

On the other hand, by guaranteeing code atomicity, embodiments of the present invention guarantee that all of the program code in the transaction will execute successfully or the transaction will fail. For example, if an instruction within the transaction causes an error and therefore does not execute successfully, the transaction will fail. Moreover, if an instruction causes an exception and is trapped, the trap is not taken (i.e., processor 102 disregards the trap), but the transaction fails.

### The Weak-Checkpoint Instruction

Generally, in embodiments of the present invention, starting a transaction involves executing a checkpoint instruction. The checkpoint instruction causes processor 102 to generate a checkpoint, which involves saving processor 102's precise architectural state to enable the recovery of the architectural state prior to the start of the transaction. When saving the architectural state, processor 102 saves information required to restart instruction execution at the point in the program code prior to the transaction starting. For example, processor 102 can save register values (or register windows, etc.), program counter(s), program stack, and other information useful for restarting execution from the checkpoint.

In embodiments of the present invention, a WEAK_CHECKPOINT instruction as one of the possible checkpoint instruction(s). As with other checkpoint instruction(s), the WEAK_CHECKPOINT instruction causes processor 102 to save processor 102's precise architectural state. However, the WEAK_CHECKPOINT instruction differs from typical checkpoint instructions because the WEAK_CHECKPOINT instruction causes processor 102 to start a semi-ordered transaction instead of a regular transaction.

In some embodiments of the present invention, the WEAK_CHECKPOINT instruction includes one or more transactional-failure fields. Each transactional-failure field holds a separate transactional-failure code. When starting a semi-ordered transaction, processor 102 records the transactional-failure code(s). If the semi-ordered transaction subsequently fails, processor 102 determines how to handle the transactional failure using the recorded transactional-failure code(s). For example, the WEAK_CHECKPOINT can include a “fail program counter” (failPC) in a transactional failure field that indicates a program counter (i.e., a location in memory) from which processor 102 should start executing error-handling code after the semi-ordered transaction fails. Alternatively, the WEAK_CHECKPOINT instruction can include a value in a transactional failure field that indicates whether the semi-ordered transaction should be re-executed in case of failure (and how many times the semi-ordered transaction should be re-executed).

### Transactions

As described in the preceding sections, embodiments of the present invention support transactional execution. During transactional execution, a processor (such as processor 102) executes a section of the program code for a thread in a transaction. Embodiments of the present invention support two types of transactions: (1) regular transactions and (2) semi-ordered transactions.

During a regular transaction, embodiments of the present invention guarantee both memory atomicity and code atomicity. Hence, a regular transaction can be used to execute a section of the program code that is to be protected from interference by other threads or processors during execution (e.g., a “critical section” of the program code). If either memory atomicity or code atomicity is violated, the regular transaction fails.

In contrast, during a semi-ordered transaction, embodiments of the present invention do not guarantee memory atomicity. Consequently, the transactional results from a semi-ordered transaction are not required to appear to other threads or processors in the system to have been committed to the architectural state of the system simultaneously. Moreover, other threads or processors can freely access memory locations accessed by instructions during a semi-ordered transaction without causing the semi-ordered transaction to fail.

However, during a semi-ordered transaction, embodiments of the present invention guarantee code atomicity. Hence, a semi-ordered transaction can be used where all of the transactional instructions must be executed successfully or else the transaction fails.

In embodiments of the present invention, semi-ordered transactions and regular transactions use some of the same transactional execution mechanisms to execute a transaction. For example, the checkpoint mechanism, the store buffering mechanism, and other such mechanisms are used during both types of transaction. Depending on the type of transaction, portions of these mechanisms may be unused or used differently. By using the same mechanisms in this way, processor 102 can efficiently execute either regular or semi-ordered transactions without significant additional transactional execution mechanisms.

### Executing a Regular Transaction

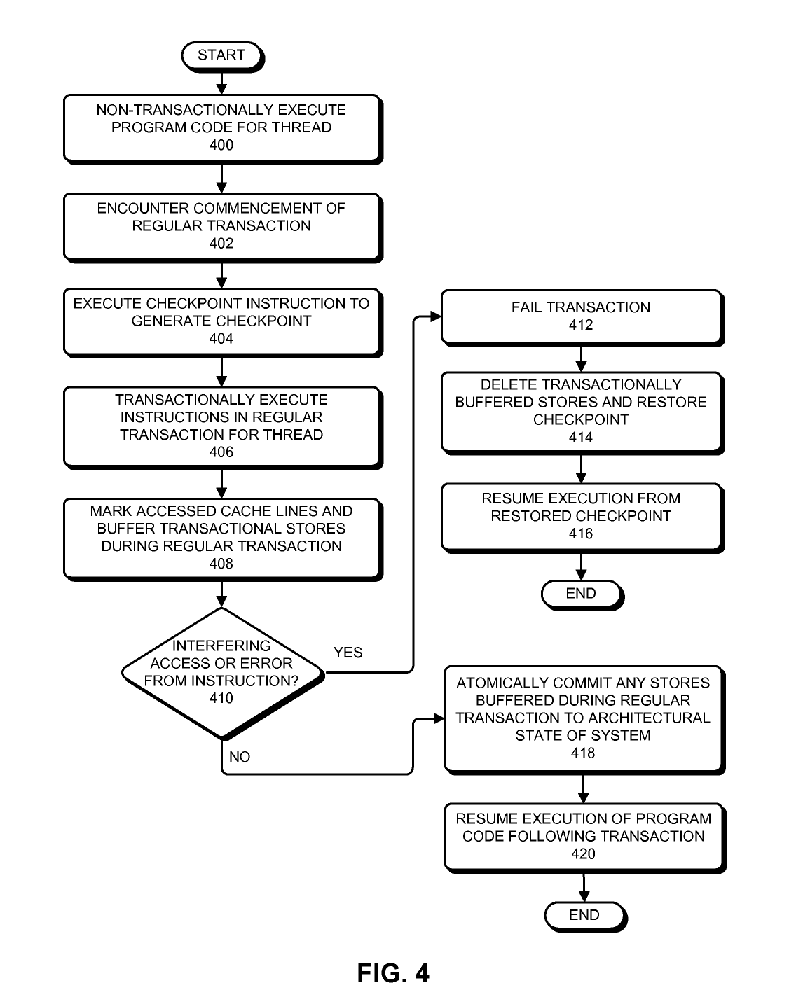

FIG. 4 presents a flowchart illustrating the process of executing a regular transaction in accordance with embodiments of the present invention. In the case of a regular transaction, processor 102 initially non-transactionally executes program code for a thread (step 400). Processor 102 then encounters the start of the regular transaction (step 402). In embodiments of the present invention, a special instruction or pattern in the program code indicates the start of a transaction. For example, a start transactional execution (STE) instruction or another special instruction can function as the indicator of the start of the regular transaction. Alternatively, certain regular instructions (e.g., LOAD instructions), sequences of instructions, method calls, or other sections of the program code can function as the indicator of the start of the regular transaction.

Before starting transactional execution for the thread, processor 102 executes a checkpoint instruction to generate a checkpoint (step 404). Recall that generating a checkpoint involves saving processor 102's precise architectural state to enable the recovery of the architectural state prior to the start of the transaction in case the transaction fails.

Next, processor 102 transactionally executes the instructions in the regular transaction for the thread (step 406). During the regular transaction, processor 102 executes instructions similarly to how instructions are executed during non-transactional execution. However, during the regular transaction, processor 102 marks accessed cache lines and buffers transactional stores (step 408). More specifically, during the regular transaction, upon encountering a load from a cache line, processor 102 loads data from the cache line and places a load-mark on the cache line in L1 cache 108. Upon encountering a store to a cache line 302, processor 102 buffers the store in STB 204 (thereby deferring the store) and places a store-mark 304 on the cache line 302 in L2 cache 114.

Note that deferring stores during the regular transaction prevents the transactional stores from affecting the architectural state of computer system 100 during the transaction. Moreover, placing the load-marks and store-marks on accessed cache lines enables computer system 100 to monitor accesses by other threads or processors to the marked cache lines.

During the regular transaction, other threads or processors are permitted only limited access to marked cache lines. For example, another thread or processor can load from a load-marked cache line. However, if another thread or processor attempts to perform an access of a cache line that could result in a return of incorrect data and/or the corruption of the data in the cache line with respect to the transactional thread or to any other thread or processor (i.e., an interfering access), processor 102 fails the regular transaction. (In alternative embodiments, upon attempting to make an interfering access, computer system 100 stalls the other thread or processor until the regular transaction is complete. In these embodiments, a regular transaction should not experience interfering memory accesses, albeit at the cost of stalling other threads or processors.)

In embodiments of the present invention, if an instruction encounters/causes an error during the regular transaction, processor 102 causes the transaction to fail. For example, if a floating-point instruction triggers a trap during the regular transaction, processor 102 does not take the trap, but instead fails the transaction.

Hence, during the regular transaction, processor 102 monitors marked cache lines to determine if an interfering access or an error from an instruction has occurred (step 410). If so, processor 102 fails the regular transaction (step 412). In embodiments of the present invention, when the regular transaction fails, processor 102 deletes the transactionally buffered stores and restores the checkpoint (step 414), thereby restoring the architectural state of processor 102 prior to the execution of the transaction. Processor 102 then resumes execution for the thread from the restored checkpoint (step 416), which can involve re-executing the regular transaction zero or more times. In some embodiments of the present invention, there is a limit on the number of times that the regular transaction is re-executed, assuming repeated failures (e.g., 3 times). After reaching the limit, processor 102 enters a locking mode, wherein processor 102 locks cache lines (or cache structures) while executing the critical section non-transactionally, to ensure the completion of execution of the critical section.

Otherwise, if the regular transaction successfully completes (step 410), processor 102 atomically commits any stores that were buffered during the regular transaction to the architectural state of computer system 100 (step 418), thereby making the stored data visible to other threads or processors in computer system 100. In embodiments of the present invention, the atomic commitment of the buffered stores involves locking each store-marked cache line 302 in L2 cache 114, writing the buffered stores to each locked cache line 302, and then removing the lock from the cache line 302. While the cache lines are locked, no other thread or processor is permitted to access the cache lines, but when the locks have been removed, the cache lines can be accessed by any thread or processor (using an appropriate cache coherency protocol such as MOESI). Hence, the buffered stores (i.e., the results of the transaction) all appear to be released to computer system 100 simultaneously, preserving memory atomicity. More specifically, there is no time when partial results from the transaction are visible to other threads or processors in the system.

Processor 102 then resumes execution of the program code for the thread following the regular transaction (step 420). Embodiments of the present invention can resume either transactional execution or non-transactional execution after the results are committed. In embodiments that resume transactional execution, results in a transaction are committed and then processor 102 returns to transactional execution. In some embodiments, resuming transactional executions enables a transaction to be halted part-way through a critical section (or between two critical sections), the results to be committed, and the transaction resumed.

### Executing a Semi-Ordered Transaction

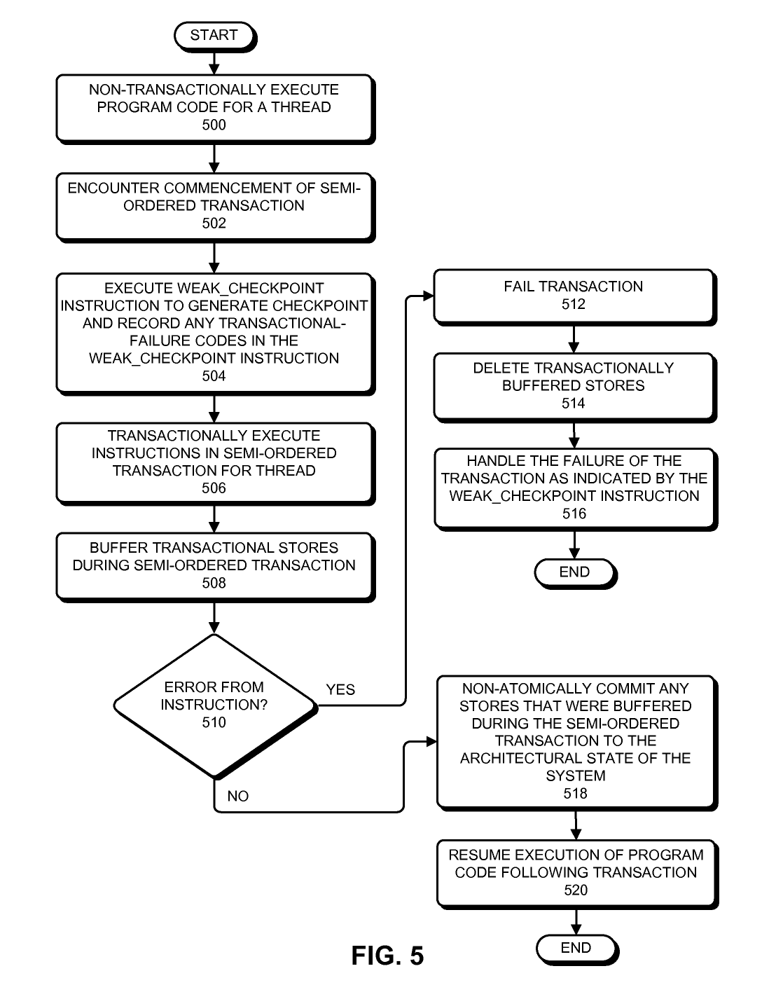

FIG. 5 presents a flowchart illustrating the process of executing a semi-ordered transaction in accordance with embodiments of the present invention. In the case of a semi-ordered transaction, processor 102 initially non-transactionally executes program code for a thread (step 500). Processor 102 then encounters the start of the semi-ordered transaction (step 502). In embodiments of the present invention, a special instruction or pattern in the program code indicates the start of the semi-ordered transaction. For example, a start transactional execution (STE) instruction or another special instruction can function as the indicator of the start of the semi-ordered transaction. Alternatively, certain regular instructions (e.g., LOAD instructions), sequences of instructions, method calls, or other sections of the program code can function as the indicator of the start of the semi-ordered transaction.

Before starting the semi-ordered transaction for the thread, processor 102 executes a WEAK_CHECKPOINT instruction to generate a checkpoint and records any transactional-failure code(s) included with the WEAK_CHECKPOINT instruction (step 504). Recall that generating a checkpoint involves saving processor 102's precise architectural state to enable the recovery of the architectural state prior to the start of the transaction in case the transaction fails.

Next, processor 102 transactionally executes the instructions in the semi-ordered transaction for the thread (step 506). During the semi-ordered transaction, processor 102 executes instructions similarly to how instructions are executed during non-transactional execution. However, during the semi-ordered transaction, processor 102 buffers any encountered stores in STB 204 (step 508) (thereby deferring the stores). Note that deferring stores during the semi-ordered transaction prevents the transactional stores from affecting the architectural state of computer system 100 during the transaction.

Because semi-ordered transactions are do not guarantee memory atomicity, cache line accesses (i.e., transactional loads and stores) are handled differently in semi-ordered transactions than they are in regular transactions. In some embodiments of the present invention, during a semi-ordered transaction, processor 102 does not place any load-marks or store-marks on cache lines accessed by transactional loads or stores. Consequently, although the system still monitors cache lines during the transaction, because there are no load-marks or store-marks on the cache lines, no interfering memory accesses by other threads or processors are detected. In alternative embodiments, processor 102 load-marks and store-marks the cache lines (as is done with a regular transaction), but subsequently ignores any interfering accesses to load-marked or store-marked cache lines by other threads or processors during the semi-ordered transaction. (Note that for clarity we present the embodiments that do not place load-marks or store-marks on cache lines in FIG. 5.) Hence, during the semi-ordered transaction, other threads or processors are allowed unrestricted access to cache lines accessed during the transaction.

In embodiments of the present invention, if an instruction encounters/causes an error during the semi-ordered transaction, processor 102 causes the transaction to fail. For example, if a floating-point instruction triggers a trap during the semi-ordered transaction, processor 102 does not take the trap, but instead fails the transaction.

Hence, during the semi-ordered transaction, processor 102 monitors instruction execution to determine if an error from an instruction has occurred (step 510). If so, processor 102 fails the semi-ordered transaction (step 512). When the semi-ordered transaction fails, processor 102 deletes the transactionally buffered stores (step 514).

Processor 102 then handles the failure of the transaction as indicated by the WEAK_CHECKPOINT instruction (step 516). In other words, processor 102 determines how to handle the failure of the transaction by reading the indicator that was originally held in the WEAK_CHECKPOINT instruction. In some cases, the indicator is a failPC, which is a program counter from which processor 102 starts executing error-handling code.

However, if no failPC (or error handling) was indicated in the WEAK_CHECKPOINT instruction, processor 102 restores the checkpoint, thereby restoring the architectural state of processor 102 prior to the execution of the transaction. Processor 102 then resumes execution for the thread from the restored checkpoint, which can involve re-executing the regular transaction or semi-ordered transaction zero or more times. In some embodiments, the transactional-failure codes (or computer system 100) places a limit on the number of times that a regular transaction is re-executed, assuming repeated failures (e.g., 3 times). After reaching the limit, processor 102 enters a locking mode, wherein processor 102 locks cache lines (or cache structures) while executing the critical section non-transactionally, to ensure the completion of execution of the critical section. Alternatively, after reaching the limit, processor 102 can follow a failPC specified by the WEAK_CHECKPOINT to start execution of error-handling code.

If semi-ordered transaction is successfully completed, processor 102 non-atomically commits any stores that were buffered during the transaction to the architectural state of computer system 100 (step 518), thereby making the stored data visible to other threads or processors in computer system 100. Note that the non-atomic commitment of the results means that the stores can be committed in any order with respect to other threads or processors (although among the buffered transactional stores, computer system 100's memory model must be observed).

Processor 102 then resumes execution of the program code for the thread following the semi-ordered transaction (step 520). Embodiments of the present invention can resume transactional execution or non-transactional execution after the results are committed. In embodiments that resume transactional execution, results in a transaction are committed and then processor 102 returns to transactional execution. In some embodiments, resuming transactional executions enables a transaction to be halted part-way through a critical section (or between two “subsections” within a critical section), the results to be committed, and the transaction resumed.

### Reordering Program Code

In embodiments of the present invention, the semi-ordered transaction can be used by a compiler to reorder sections of program code. In these embodiments, the reordered program code is ordered to make more effective use of computational resources, thereby enabling the reordered program code to execute more efficiently than the program code in its original order. Because a semi-ordered transaction is used by the compiler, these embodiments take advantage of code atomicity, without the control/monitoring overhead and performance degradation inherent in maintaining memory atomicity during a regular transaction. In these embodiments, because transactional results are buffered during the transaction, processor 102 can delete these results (and recover to the checkpoint), thereby preventing the transaction from having any affect on the processor 102 or the architectural state of computer system 100.

Generally, although compilers perform many optimizations when compiling source code into executable code, compilers must respect certain types of program ordering. For example, because floating-point instructions can cause an exception (and thus be trapped), compilers often organize a sequence of consecutive floating point operations so that they appear in the executable program in the same order as they appear in the source code, as a result, typically no more than one floating point operation is executing at a time, which can lead to sub-optimal use of computational resources. Consequently, if there are no other operations to intersperse, the compiled code may result in dead cycles or bubbles during execution, during which no instructions are executing, leading to further reductions in the usage effectiveness of the computational resources. (Without operations to intersperse, some compilers explicitly place discreet no-ops in the program code.)

In another example, the compiler may need to respect the order of a series of branch instructions intermixed with other types of instructions. Such a sequence is shown in the following simplified pseudocode snippet:

if(condition1) break;
store1;
if(condition2) break;
store2;
...
if(conditionN) break;
storeN.

Because any of the conditional instructions cause a branch during execution, the compiler cannot schedule subsequent instructions ahead of the conditional instructions. For example, store1 cannot be scheduled ahead of “if (condition1),” because if“condition1” evaluates true, processor 102 branches to another location in the program code. However, scheduling the branches and the other operations in the program order can lead to sub-optimal use of computational resources. Aside from these examples, there are many other situations where a compiler's observation of program ordering while scheduling program code leads to sub-optimal use of computational resources.

However, during execution, some failure cases (including those presented above) occur very rarely. Consequently, temporarily ignoring the possibility of failure and proceeding with execution of program code can lead to significant gains in performance. (Although the potential failures must be accounted for.)

Hence, in embodiments of the present invention, the compiler reorders sections of the program code and places the reordered sections within a semi-ordered transaction. The reordered program code is in an order that is optimized for the computational resources available on processor 102, but that may not comply with the original program order. For example, the compiler may arrange the program code so that a floating-point operation is issued into the floating point execution unit before the prior floating-point operation has passed the trap stage of the pipeline. Because the semi-ordered transaction guarantees code atomicity, all the instructions in the semi-ordered transaction are guaranteed to execute successfully or the transaction fails. In addition, the transactional results are not committed to the architectural state of computer system 100 until the semi-ordered transaction has completed.

In embodiments of the present invention, while reordering a section of the program code, the compiler places an explicit FAIL instruction in the semi-ordered transaction that causes the transaction to fail immediately in the event that an error has occurred. For example, the compiler may aggregate a number of conditional branches into a single test case at the end of a series of operations, thereby allowing the other operations to execute without evaluating each branch separately during execution. Such a series (from the example above) is shown in the following pseudocode snippet:

store1;
store2;
...
storeN;
if(condition1 || condition2 || ... || conditionN) FAIL.

In embodiments of the present invention, the compiler designates the normally-ordered program code as an error handler. In other words, during compilation, the compiler can reorder the section of the program code, but can also place the program-order version of the section of the program code at a different location within the compiled program. At runtime, if the reordered section of the program code causes the semi-ordered transaction to fail, processor 102 deletes the transactional results from STB 204, restores the checkpoint set upon starting the semi-ordered transaction (which restores processor 102 to a pre-transactional state), and executes the program-order version of the section of the program code. In order to enable the error handling, the compiler includes a failPC in a transactional-failure field of the original WEAK_CHECKPOINT instruction which indicates the location within the program (i.e., within memory) of the program-order version of the section of the program code.

In some embodiments of the present invention, the compiler is a static compiler. In alternative embodiments, the compiler is a dynamic compiler. For example, the compiler can be a just-in-time (JIT) JAVA compiler from Sun Microsystems, Inc. of Santa Clara, Calif., USA.

Compiling Program Code

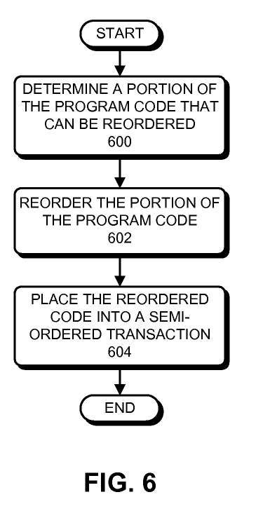

FIG. 6 presents a flowchart illustrating the process of reordering program code in accordance with embodiments of the present invention. The process starts during the compilation of a program code with a compiler determining a section of the program code that can be reordered (step 600). When determining a section of the program code that can be reordered, the compiler determines a section of the program code that, if executed in program order, would make suboptimal use of computational resources.

The compiler then reorders the section of the program code (step 602) and places the reordered code into a semi-ordered transaction (step 604). When reordering the code, the compiler orders the code so that at runtime processor 102 can make more effective use of the computational resources than was made using the original program order.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for facilitating transactional execution in a processor, comprising:
executing program code for a thread in the processor; and
upon detecting a predetermined indicator, starting a transaction for a section of the program code for the thread, wherein starting the transaction involves:
executing a checkpoint instruction,
wherein if the checkpoint instruction is a WEAK_CHECKPOINT instruction, executing a semi-ordered transaction, which involves preserving code atomicity, but not memory atomicity during the transaction,
otherwise, executing a regular transaction, which involves preserving both code atomicity and memory atomicity during the transaction.

2. The method of claim 1, wherein preserving code atomicity involves either successfully executing each instruction in the transaction or failing the transaction; and
wherein preserving memory atomicity involves either protecting each memory location accessed during the transaction from interfering accesses by other threads during the transaction or failing the transaction.

3. The method of claim 2, wherein starting the semi-ordered transaction involves storing at least one transactional-failure code from a transactional-failure field included in the WEAK_CHECKPOINT instruction.

4. The method of claim 3, wherein if an instruction in the section of the program code causes an error during the semi-ordered transaction, the method further comprises:
failing the semi-ordered transaction;
obtaining the stored transactional-failure code from the WEAK_CHECKPOINT instruction; and
executing program code specified by the transactional-failure code.

5. The method of claim 4, wherein executing the program code indicated by the transactional-failure code involves executing error-handling code starting at a transactional failure program counter (failPC) included in the transactional-failure code.

6. The method of claim 4, wherein executing the checkpoint instruction involves generating a checkpoint to save a precise architectural state of the processor to enable recovery of a program state prior to starting the transaction.

7. The method of claim 6, wherein executing program code specified by the transactional-failure code involves:
determining if the transaction is to be re-executed;
if so, restoring the precise architectural state of the processor using the checkpoint and re-executing the transaction; and
otherwise, either restoring the checkpoint and executing the program code non-transactionally, or executing separate error-handling program code.

8. The method of claim 1, wherein detecting the predetermined indicator involves detecting a special instruction or a pattern in the program code that indicates a start of the transaction.

9. An apparatus for facilitating transactional execution, comprising:
a processor that is configured to execute program code for a thread;
wherein upon detecting a predetermined indicator in the program code, the processor is configured to start a transaction for a section of the program code for the thread, wherein starting the transaction involves:
executing a checkpoint instruction,
wherein if the checkpoint instruction is a WEAK_CHECKPOINT instruction, the processor is configured to execute a semi-ordered transaction, which involves preserving code atomicity, but not memory atomicity during the transaction,
otherwise, the processor is configured to execute a regular transaction, which involves preserving both code atomicity and memory atomicity during the transaction.

10. The apparatus of claim 9, wherein when preserving code atomicity, the processor is configured to either successfully execute each instruction in the transaction or fail the transaction; and
wherein when preserving memory atomicity, the processor is configured to either protect each memory location accessed during the transaction from interfering accesses by other threads during the transaction or fail the transaction.

11. The apparatus of claim 10, wherein when starting the semi-ordered transaction, the processor is configured to store at least one transactional-failure code from a transactional-failure field included in the WEAK_CHECKPOINT instruction.

12. The apparatus of claim 11, wherein if an instruction in the section of the program code causes an error during the semi-ordered transaction, the processor is configured to:
fail the semi-ordered transaction;
obtain the stored transactional-failure code from the WEAK_CHECKPOINT instruction; and
execute program code specified by the transactional-failure code.

13. The apparatus of claim 12, wherein when executing the program code indicated by the transactional-failure code, the processor is configured to execute error-handling code starting at a transactional failure program counter (failPC) included in the transactional-failure code.

14. The apparatus of claim 12, wherein when executing the checkpoint instruction, the processor is configured to generate a checkpoint to save a precise architectural state of the processor to enable recovery of a program state prior to starting the transaction.

15. The apparatus of claim 14, wherein when executing program code specified by the transactional-failure code, the processor is configured to:
determine if the transaction is to be re-executed;
if so, restore the precise architectural state of the processor using the checkpoint and re-execute the transaction; and
otherwise, either restore the checkpoint and execute the program code non-transactionally, or execute separate error-handling program code.

16. The apparatus of claim 9, wherein when detecting the predetermined indicator, the processor is configured to detect a special instruction or a pattern in the program code that indicates a start of the transaction.

17. A computer system for facilitating transactional execution, comprising:
a processor that is configured to execute program code for a thread;
a cache coupled to the processor, wherein the cache is configured to store data for the processor;
wherein upon detecting a predetermined indicator in the program code, the processor is configured to start a transaction for a section of the program code for the thread, wherein starting the transaction involves:
executing a checkpoint instruction,
wherein if the checkpoint instruction is a WEAK_CHECKPOINT instruction, the processor is configured to execute a semi-ordered transaction, which involves preserving code atomicity, but not memory atomicity during the transaction,
otherwise, the processor is configured to execute a regular transaction, which involves preserving both code atomicity and memory atomicity during the transaction.

18. The computer system of claim 17, wherein when preserving code atomicity, the processor is configured to either successfully execute each instruction in the transaction or fail the transaction; and
wherein when preserving memory atomicity, the processor is configured to either protect each memory location accessed during the transaction from interfering accesses by other threads during the transaction or fail the transaction.

19. A computer-readable storage medium storing instructions that when executed by a computer cause the computer to perform a method for reordering program code, the method comprising:
determining an original section of program code that can be reordered;
reordering the original section of program code, wherein reordering the original section of program code involves placing instructions in the original section of program code in an order that is optimized for a set of available computational resources in a processor that will execute the program code but is not in strict program order;
placing the reordered section of the program code into a semi-ordered transaction, wherein at runtime the semi-ordered transaction preserves code atomicity but not memory atomicity for the reordered section of the program code; and
replacing the original section of program code with the semi-ordered transaction.

20. The computer-readable storage medium of claim 19, wherein placing the reordered section of the program code into the semi-ordered transaction involves placing a WEAK_CHECKPOINT instruction at a start of the semi-ordered transaction, wherein at runtime the WEAK_CHECKPOINT instruction causes the processor to execute a semi-ordered transaction.

21. The computer-readable storage medium of claim 20, wherein the method further comprises placing at least one transactional-failure code in at least one transactional-failure field in the WEAK_CHECKPOINT instruction, wherein the transactional-failure code specifies program code to be executed if an instruction in the semi-ordered transaction causes an error at runtime.

22. The computer-readable storage medium of claim 21, wherein the method further comprises:
placing the original section of the program code within the program code at a different location than the semi-ordered transaction; and
setting the transactional-failure code in the WEAK_CHECKPOINT instruction to indicate the original section of the program code as program code to be executed in the event that an instruction in the semi-ordered transaction causes an error at runtime.

23. The computer-readable storage medium of claim 19, wherein preserving code atomicity at runtime involves either successfully executing each instruction in the transaction or failing the transaction; and
wherein preserving memory atomicity at runtime involves either protecting each memory location accessed during the transaction from interfering accesses by other threads during the transaction or failing the transaction.
